(19) United States
(12) Patent Application Publication
(10) Pub. No.: US 2003/0224243 A1
(43) Pub. Date: Dec. 4, 2003

(54) Remote controller with a spare battery storage and mobile electronic apparatus

(76) Inventor: Osamu Maeda, Osaka (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/375,055

(22) Filed: Feb. 28, 2003

(30) Foreign Application Priority Data
Mar. 1, 2002 (JP) 2002-55365

(51) Int. Cl. H01M 2/10

(52) U.S. Cl. 429/100; 361/600; 340/693.2; 340/825.72; 348/734; 455/95; 455/41.2

(57) ABSTRACT

A remote controller is provided comprising an array of operating keys arranged to be actuated by a user, a control circuit for controlling the action of corresponding components in response to the movement of the operating keys, a signal transmitter arranged responsive to control commands of the control circuit determined by the movement of the operating keys for transmitting radio signals, a case containing the above components therein, a battery holder provided in the case for holding dry cells to supply the power, and a spare battery storage provided in the case for storing spare dry cells which replace exhausted dry cells in the battery holder. When the dry cells in the battery holder are exhausted, they are removed out from the battery holder. Then, the spare dry cells in the spare battery storage are loaded into the battery holder. This can facilitate replacement of the dry cells.

### BACKGROUND OF THE INVENTION

1. Field of the Invention

The present invention relates to a remote controller for use with a dry battery installed in a main housing thereof and to a mobile electronic apparatus.

2. Description of the Related Art

There has been provided a mobile electronic apparatuses having a dry battery installed in a main housing thereof for use, such as a remote controller for television receiver, video player, or air conditioner. One of such conventional remote controllers is schematically shown in FIGS. 4A and 4B. FIG. 4A is a plan view of the conventional remote controller seen from the back and FIG. 4B is a side view of the same seen from a direction denoted by the arrow X of FIG. 4A. The conventional remote controller 40 has an array of push-button type operating keys 43 provided on the front side of a case 42. A signal transmitter 44 is provided at the front end of the case 42 for transmitting radio signals. Also, a circuit board 48 is provided in the interior of the case 42.

The circuit board 48 has an array of electric switches (not shown) provided thereon at a position corresponding to the array of the operating keys 43 for opening and closing actions in response to the pressing actions of the operating keys 43. Also, the circuit board 48 has a control circuit 49 provided therein for detecting the pressing action of the operating keys 43 from its electric switches and transmitting a corresponding radio signal from the signal transmitter 44.

The remote controller 40 includes a battery holder 46 for holding dry cells B. As its signal transmitter 44 and control circuit 49 are supplied with power from the dry cells B held in the battery holder 46, the remote controller 40 can be operated.

The battery holder 46 is located at the proximal end of the case 42 and accessed through an openable bottom cover 45 provided in the back side of the case 42. More specifically, the two dry cells B are placed in parallel to each other transversely of the case 42 as accommodated in the battery holder 46 of the case 42. Each of the dry cells B is detachably gripped by a pair of terminal springs 46a and 46b which are elastic to contact the positive and negative electrodes of the dry cell B respectively. The power from the dry cell B is fed via the terminal springs 46a and 46b to the signal transmitter 44 and the control circuit 49.

The battery holder 46 is particularly positioned not to overlap the circuit board 48. This is contemplated for reducing the thickness of the case 42 and thus thinning the remote controller 40. Alternatively, a region of the remote controller 40 where the battery holder 46 is located may be saved for the maximum of thickness to provide a certain degree of rigidity while the other is minimized in the thickness, hence contributing to the thinning of the remote controller 40. However, the conventional remote controller 40 of the described construction locates the battery holder 46 at this side of the circuit board 48 in order to avoid their overlapping and its overall length will be increased.

For minimizing the overall length, another conventional remote controller is proposed as shown in FIGS. 5A, 5B, and 5C. FIG. 5A is a plan view of the another remote controller seen from the back, FIG. 5B is a side view of the same seen from a direction denoted by the arrow X of FIG. 5A, and FIG. 5C is an end view of the same seen from another direction denoted by the arrow Y of FIG. 5A.

The remote controller 40 shown in FIGS. 5A, 5B, and 5C has a battery holder 46 provided in one side of a case 42 thereof. A couple of dry cells B are placed in a row lengthwisely of the case 42 as accommodated in the battery holder 46 of the case 42. The battery holder 46 is arranged to overlap a circuit board 48. The case 42 is shaped to have a humped or thickened region at the back of its one side for clearing some space for the battery holder 46.

The remote controller 40 allows the battery holder 46 to overlap the circuit board 48 and its overall length can be minimized while its thickness is increased. Also, one pair of terminal springs 46a and 46b can successfully be eliminated.

Alternatively, when the remote controller 40 shown in FIGS. 5A, 5B, and 5C may be modified with its battery holder 46 located at the center of the case 42. In that case, the case 42 is shaped to have a humped region at the center thereof as shown in FIG. 6. FIG. 6 is an end view of a modification of the remote controller 40 seen from the proximal end as is compared to FIG. 5C.

It is also known to provide a spare battery device for use with such a mobile electronic apparatus, which incorporates a battery box containing dry cells and attached as a spare power source to the electronic apparatus to allow no exchange of the dedicated battery installed in the electronic apparatus (See Japanese Patent Laid-open Publication No. HEI 11-25944). Another example is a battery for use with a mobile electronic apparatus which incorporates a battery case containing both types of cells, rechargeable cells and dry cells, and attached to a housing of the electronic apparatus so that the rechargeable cells and the dry cells can be used selectively depending on the direction of attaching the battery case (See Japanese Patent Laid-open Publication No. HEI 11-329388).

The remote controller 40 which has two dry cells B installed lengthwisely of the case 42 permits the case 42 to be humped at the back side as shown in FIGS. 5C and 6C. Such a hump at the back side of the case 42 is shaped to make room for the battery holder 46 as extends along the lengthwise direction of the case 42. This causes the remote controller 40 to sit unsteadily on a desk or the like hence declining its handling property. It is thus needed for eliminating such a drawback to provide another hump (a projecting region) on the back side of the case 42 as high as of the battery holder 46.

Also, when the dry cells are exhausted, they have to be replaced by new ones to power the remote controller 40. However, new dry cells are not available at hand or their stock may often be lost in mind. Accordingly, it takes a considerable length of time before new dry cells are purchased or taken from the storage.

The prior arts disclosed in the Publication Nos. HEI 11-25944 and HEI 11-329388 are directed towards separate power sources which are attached to their corresponding electronic apparatuses and may hardly be decreased in the overall size. Both also fail to improve the seated condition. No prior arts are successful to eliminate the above disadvantages.

### SUMMARY OF THE INVENTION

The present invention has been developed for eliminating the above disadvantages and its object is to provide a remote controller and a mobile electronic apparatus characterized in that a spare battery storage is provided for storing spare dry cells and permitting the current dry cells when exhausted to be readily replaced with the spare dry cells with no troublesome action of searching new or unused dry cells and also arranged to be minimized in the size and specifically accommodated in a main housing or case so as not to form any irregular humps on the back side of the case, hence increasing the placement stability of the back side of its case and improving the usability of the controller or apparatus.

An aspect of the present invention provides a remote controller which is energized by power from dry cells for transmitting radio signals to remote control an apparatus to be controlled, comprising: an array of operating keys arranged to be actuated by a user; a control circuit for controlling the action of corresponding components in response to the movement of the operating keys; a signal transmitter arranged responsive to control commands of the control circuit determined by the movement of the operating keys for transmitting the radio signals; a case containing the above components therein; a battery holder provided in the case for holding the dry cells with its electrodes connected to power supply terminals to supply the power for enabling the action of the corresponding components; and a spare battery storage provided in the case for storing spare dry cells which replace exhausted dry cells in the battery holder.

According to the present invention, when the dry cells held in the battery holder are exhausted, they can be expelled from the battery holder and replaced with no delay by the spare dry cells which have been stored and taken out from the spare battery storage. This can facilitate the replacement of exhausted dry cells with new and unused dry cells without any downtime for searching the spare dry cells. As the result, the remote controller can continuously be used without difficulty.

Another aspect of the present invention provides a mobile electronic apparatus which is energized by power from dry cells, comprising: an array of operating keys arranged to be actuated by a user; a control circuit for controlling the action of corresponding components in response to the movement of the operating keys; a case containing the above components therein; a battery holder provided in the case for holding the dry cells with its electrodes connected to power supply terminals to supply the power for enabling the action of the corresponding components; and a spare battery storage provided in the case for storing spare dry cells which replace exhausted dry cells in the battery holder.

According to the present invention, any form of the mobile electronic apparatus can also provide the same advantage as of the remote controller.

### BRIEF DESCRIPTION OF THE DRAWINGS

FIG. 1A is a perspective view of a remote controller seen from the front, showing one embodiment of the present invention and FIG. 1B is a perspective view of the same seen from the back;

FIG. 2A is a plan view of the remote controller seen from the back, FIG. 2B is a side view of the same, and FIG. 2C is an end view of the same seen from the proximal end;

FIG. 3A is a plan of a remote controller seen from the back, showing another embodiment of the present invention and FIG. 3B is an end view of the same seen from the proximal end;

FIG. 4A is a plan view of a conventional remote controller seen from the back and FIG. 4B is a side view of the same;

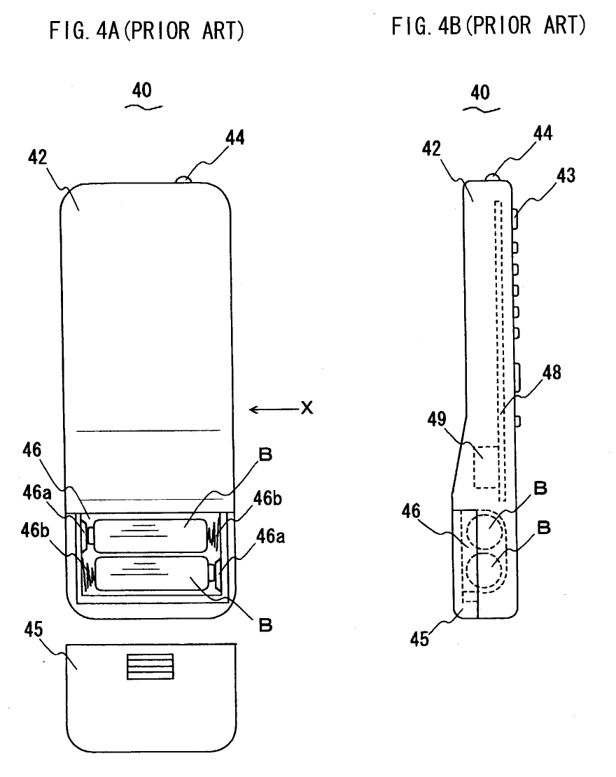

FIG. 5A is a plan view of another conventional remote controller seen from the back, FIG. 5B is a side view of the same, and FIG. 5C is an end view of the same seen from the proximal end; and

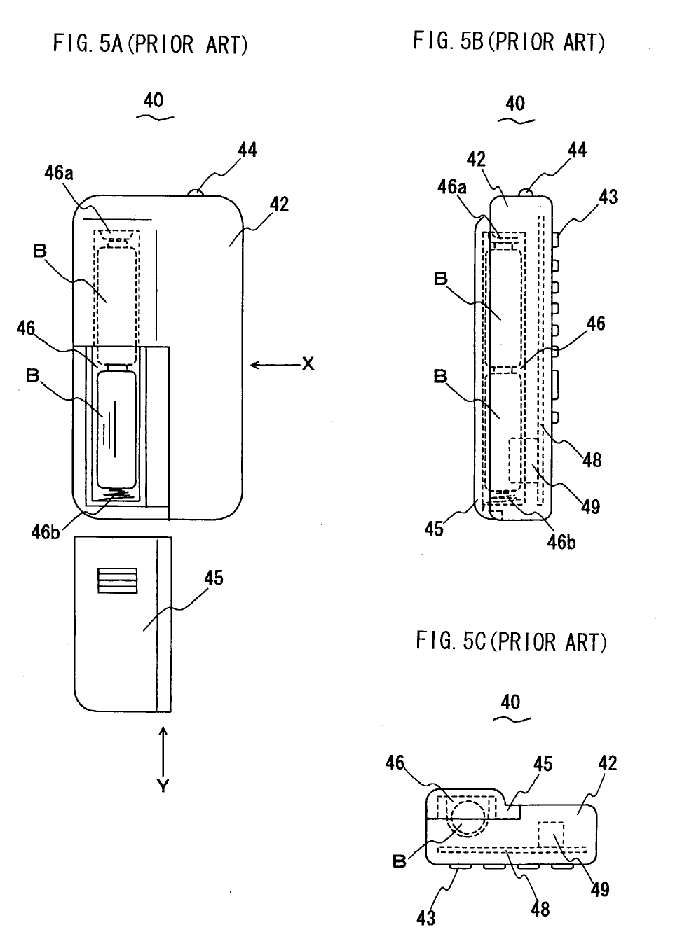

FIG. 6 is a side view a further conventional remote controller seen from the proximal end.

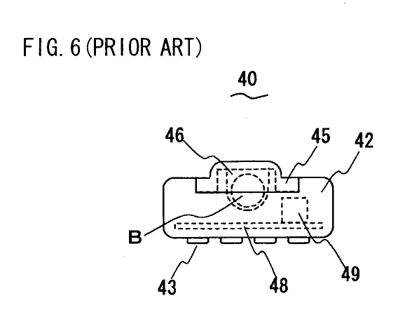

### DETAILED DESCRIPTION OF THE EMBODIMENTS

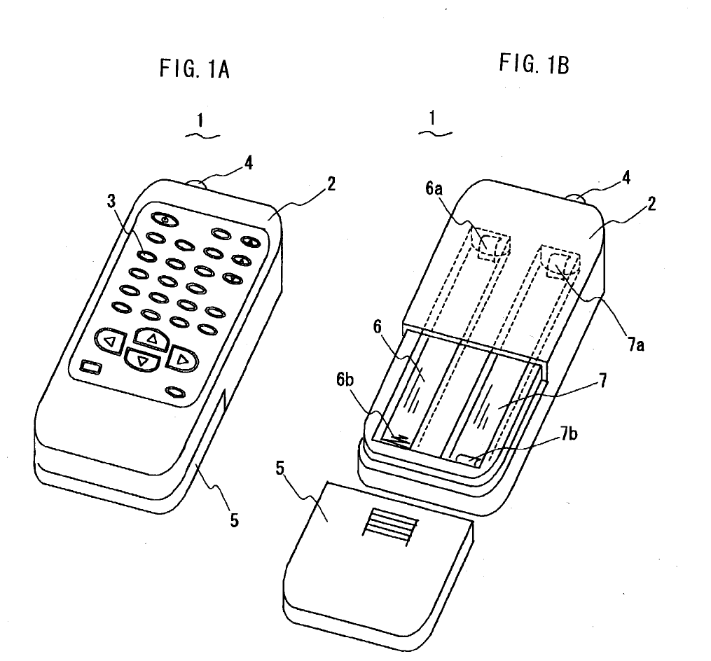

Some embodiments of the present invention will be described in more detail referring to the relevant drawings. FIGS. 1A and 1B illustrate a schematic arrangement of the remote controller provided as a mobile electronic apparatus according to one embodiment of the present invention. FIG. 1A is a perspective view of the remote controller seen from the back. The remote controller 1 includes an array of push-button type operating keys 3 provided on the front side of a case 2 thereof for remote controlling an unshown system to be controlled. Also, a signal transmitter 4 is provided at the front end of the case 2 for transmitting radio signals such as infrared ray signals in response to the pressing action of the operating keys 3. The remote controller 1 includes an openable bottom cover 5 provided on the proximal end of the back side of the case 1.

The remote controller 1 further includes a battery holder 6 which carries electric cells therein for feeding power to each section of the remote controller 1 and a spare battery storage 7 for storing (new and unused) spare electric cells which replace the exhausted electric cells held in the battery holder 6. The loading of electric cells to the battery holder 6 and to the battery storage 7 can be made with the bottom cover 5 opened.

The battery holder 6 is located at one side of the case 2 for holding two round SUM-3 electric cells aligned lengthwisely in a row (in series connection) in the case 2. The battery holder 6 has a pair of electrically conductive terminal springs 6a and 6b which come in direct contact with the positive and negative electrodes of cells respectively. While detachably holding dry cells with its terminal springs 6a and 6b, the battery holder 6 dispatches power from the dry cells via the terminal springs 6a and 6b to each component of the remote controller 1.

The spare battery storage 7 is located at the other side of the case 2 and opposite to the battery holder 6. The spare battery storage 7 is shaped to hold two round SUM-3 dry cells aligned lengthwisely in a row (in series relationship) in the case 2. The two round SUM-3 dry cells in the spare battery storage 7 are held at similar positional relationship along the lengthwise direction of the case 2 and in parallel to the two dry cells in the battery holder 6. The spare battery storage 7 also has a pair of resin springs 7a and 7b provided integral with the case 2 as arranged to act as elastic clamps made of an elastic resin material for clamping the dry cells. As the dry cells are detachably clamped with the resin springs 7a and 7b of the spare battery storage 7, it can securely stay without wobbling in the case 2.

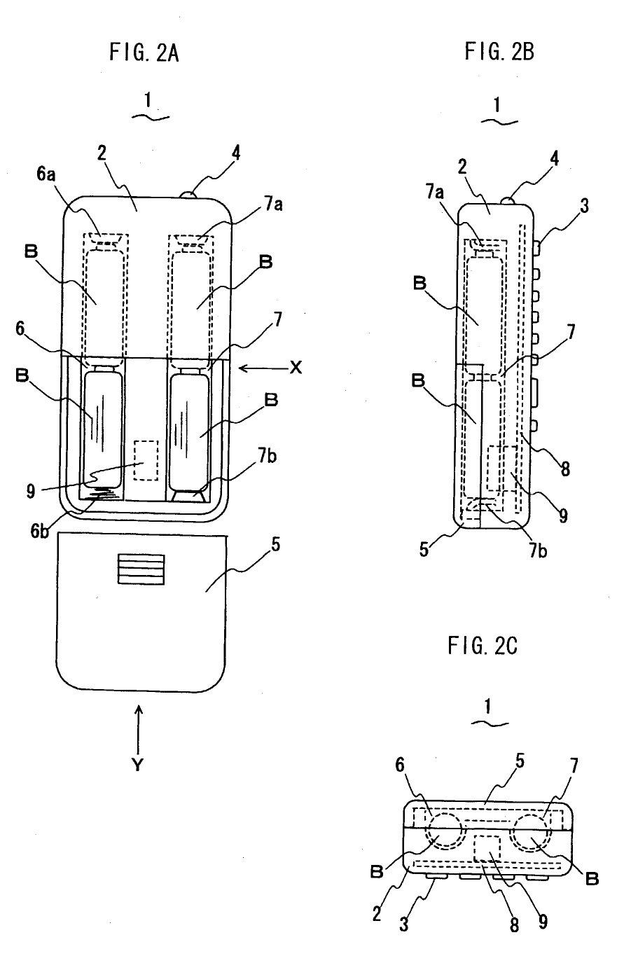

The remote controller 1 includes a circuit board 8 accommodated in the case 2 and a control circuit 9 mounted on the circuit board 8, as shown in FIGS. 2A, 2B, and 2C. FIG. 2A is a plan view of the remote controller 1 seen from the back, FIG. 2B is a side view of the same seen from a direction denoted by the arrow X of FIG. 2A, and FIG. 2C is an end view of the same seen from a direction denoted by the arrow Y.

The circuit board 8 has an array of electric switches (not shown) provided thereon at a position corresponding to the array of the operating keys 3 for opening and closing actions in response to the pressing actions of the operating keys 3. This allows the control circuit 9 to detect the pressing action of the operating keys 3 from the opening and closing motion of its electric switches and transmit a corresponding radio signal of e.g. infrared ray form from the signal transmitter 4.

The battery holder 6 and the spare battery storage 7 are located beneath the circuit board 8 at overlap relationship with the circuit board 8. The control circuit 9 mounted on the circuit board 8 stays at a position between the battery holder 6 and the spare battery storage 7 where non of the operating keys 3 is involved (i.e. the electric switches are not present). The back side of the case 2 has two humped regions for accepting the battery holder 6 and the spare battery holder 7 respectively arranged identical in the height.

The battery holder 6 is designed to hold two dry cells B in a row. More specifically, the positive electrode of one of the two dry cells B is held directly with the terminal spring 6a while the negative electrode of the other is held directly with the terminal spring 6b. The spare battery storage 7 is designed to save another pair of dry cells B in a row. In the drawing, the positive electrode of one of the another two dry cells B is held directly with the resin spring 7a while the negative electrode of the other is held directly with the resin spring 7b. They may be held with their positive and negative electrodes oriented in a reverse manner.

When the two dry cells B in the battery holder 6 are exhausted and fail to energize the remote controller 1, they are taken out from the battery holder 6 with the bottom cover 5 opened. Then, the battery holder 6 is reloaded with the another pair of the dry cells B from the spare battery storage 7. When the replacement of dry cells is completed, the remote controller 1 can be ready for carrying out the controlling action.

As described, the remote controller 1 of this embodiment allows a pair of spare dry cells B to be held in the spare battery storage 7 and readily taken to replace the dry cells B in the battery holder 6 which have been exhausted. Also, the back side of the case 2 is equal in the height between the humped region where the battery holder 6 is formed and the humped region where the spare battery storage 7 is formed. Accordingly, the back side of the case 2 has no irregular humps and can thus be improved in the seating stability.

As both the battery holder 6 and the spare battery storage 7 are arranged to extend in parallel to each other lengthwisely of the case 2, the size of the case 2 along the lengthwise direction can be decreased. Also, as both the battery holder 6 and the spare battery storage 7 are arranged to overlap the circuit board 8, the size of the case 2 along the traverse direction as well as the lengthwise direction. Moreover, as the control circuit 9 is positioned at a space between the battery holder 6 and the spare battery storage 7, the case 2 can be improved in the utilization of space and its overall size will further be decreased. As spare dry cells B are held by the elastic effect of the resin springs 7a and 7b in the spare battery storage 7, they can stay steady without wobbling in the case 2.

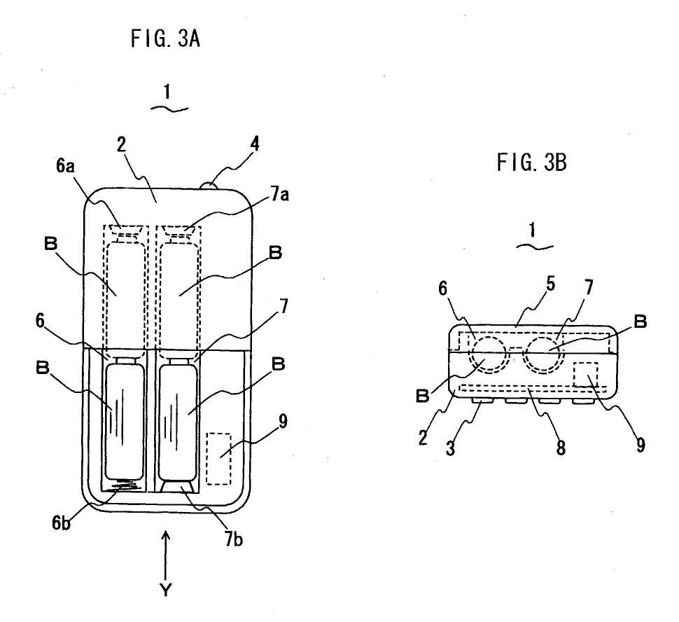

The present invention is not limited to the above described embodiment and may be implemented by other appropriate embodiments. For example, another form of the remote controller 1 can be made as shown in FIGS. 3A and 3B. FIG. 3A is a plan view of the another remote controller 1 seen from the back and FIG. 3B is a side view of the same seen from a direction denoted by Y of FIG. 3A. This embodiment allows the spare battery storage 7 to be located next to the battery holder 6 with the control circuit 9 provided next to the battery holder 6. The other arrangement is identical to that of the previous embodiment. This embodiment can also provide the same advantageous effects as of the previous embodiment.

The resin springs 7a and 7b of the previous embodiment may be replaced by metallic springs. The present invention is not limited to a remote controller but may be embodied in the form of any mobile electronic apparatus with electric cells installed therein. The present application declares a priority right based on the prior art application filed on Mar. 1, 2002. The teaching of this application hence covers the entirety of the prior art application as a reference.

What is claimed is:

1. A remote controller which is energized by power from dry cells for transmitting radio signals to remote control an apparatus to be controlled, comprising:
an array of operating keys arranged to be actuated by a user;
a control circuit for controlling the action of corresponding components in response to the movement of the operating keys;
a signal transmitter arranged responsive to control commands of the control circuit determined by the movement of the operating keys for transmitting the radio signals;
a case containing the above components therein;
a battery holder provided in the case for holding the dry cells with its electrodes connected to power supply terminals to supply the power for enabling the action of the corresponding components; and
a spare battery storage provided in the case for storing spare dry cells which replace exhausted dry cells in the battery holder.

2. A remote controller according to claim 1, wherein the spare battery storage includes elastic clamps for clamping the spare dry cells.

3. A remote controller according to claim 1, wherein the battery holder holds two or more dry cells connected in series and its power supply terminals connect directly to two opposite electrodes of end side ones of the dry cells.

4. A remote controller according to claim 3, wherein the spare battery storage stores two or more spare dry cells connected in series.

5. A remote controller according to claim 4, wherein the spare battery storage stores a row of the spare dry cells extending next to and in parallel to a row of the dry cells in the battery holder.

6. A remote controller according to claim 1, wherein the control circuit is mounted on a circuit board which is arranged to overlap both the battery holder and the spare battery storage.

7. A remote controller according to claim 6, wherein the control circuit is located between the battery holder and the spare battery storage.

8. A mobile electronic apparatus which is energized by power from dry cells, comprising:
an array of operating keys arranged to be actuated by a user;
a control circuit for controlling the action of corresponding components in response to the movement of the operating keys;
a case containing the above components therein;
a battery holder provided in the case for holding the dry cells with its electrodes connected to power supply terminals to supply the power for enabling the action of the corresponding components; and
a spare battery storage provided in the case for storing spare dry cells which replace exhausted dry cells in the battery holder.

9. A mobile electronic apparatus according to claim 8, wherein the spare battery storage includes elastic clamps for clamping the spare dry cells.

10. A mobile electronic apparatus according to claim 8, wherein the battery holder holds two or more dry cells connected in series and its power supply terminals connect directly to two opposite electrodes of end side ones of the dry cells.

11. A mobile electronic apparatus according to claim 10, wherein the spare battery storage stores two or more spare dry cells connected in series.

12. A mobile electronic apparatus according to claim 11, wherein the spare battery storage stores a row of the spare dry cells extending next to and in parallel to a row of the dry cells in the battery holder.

13. A mobile electronic apparatus according to claim 8, wherein the control circuit is mounted on a circuit board which is arranged to overlap both the battery holder and the spare battery storage.

14. A mobile electronic apparatus according to claim 13, wherein the control circuit is located between the battery holder and the spare battery storage.
